(19) United States
(12) Patent Application Publication
(10) Pub. No.: US 2003/0051144 A1
(43) Pub. Date: Mar. 13, 2003

(54) Dynamic electronic chain-of-trust document with audit trail

(76) Inventor: Terry N. Williams, Raleigh, NC (US)

Correspondence Address: CLIFFORD CHANCE US LLP, 200 PARK AVENUE, NEW YORK, NY, 10166, US

(21) Appl. No.: 10/026,219

(22) Filed: Dec. 20, 2001

Related U.S. Application Data
(60) Provisional application No. 60/258,297, filed on Dec. 22, 2000.

(51) Int. Cl. H04L 9/00

(52) U.S. Cl. 713/178; 713/182

(57) ABSTRACT

A system and method for processing form documents across a communications network that includes a first access device, a second access device and a form server is provided that includes the steps of receiving one or more requests from an operator of the first access device to process a form document, determining whether the operator of the first access device is authorized to process the document, receiving one or more responses including information from the first operator to complete the form, receiving one or more requests from an operator of the second access device to process the form document, determining whether the operator of the second access device is authorized process document, and receiving one or more responses from the second operator including information to complete the form. The system may determine whether the operators of the access devices have the proper credentials to access or modify a particular form document or particular section of a form document. The system may require submission of a digital signature by an operator and record the date and time the digital signature was submitted and not permit the form to be modified until an additional digital signature is submitted and an additional date and time recorded.

### CROSS REFERENCE TO RELATED APPLICATIONS

This application claims priority to U.S. Provisional Patent Application No. 60/258,297 filed on Dec. 22, 2000.

### FIELD OF THE INVENTION

The technical field is integrated computer system design for the healthcare industry including the segment addressing the home healthcare services. This invention will impact the interaction among patients, suppliers, physicians and other healthcare professionals, and third party payors for healthcare reimbursement programs.

More specifically, the present invention is an improvement that solves problems existing in the healthcare payment sector of the economy. Putting the problem in its simplest form, most people have a third party payor that pays all or part of certain expenses for medical goods and services. A problem is that the party paying for the goods and services is not on the scene when the goods or services are authorized. Thus, the third party payors want an audit trail that can be used to document that a physician actually authorized the provision of certain goods or services for a particular patient in response to a medical need. Sometimes this authorization is coupled with additional collected information such as particulars about the patient's medical situation so that the third party payor can audit whether goods and services are being authorized in keeping with the relevant guidelines. The present invention provides a secure healthcare transaction network that embraces requirements for supporting healthcare documentation in the healthcare marketplace under the proposed regulations to implement the Health Insurance Portability and Accountability Act of 1996. (“HIPAA”).

### BACKGROUND OF THE INVENTION

The above description applies to many situations. However, in order to provide an orderly presentation of the present invention, this document will use as an example the process of creating a Certificate of Medical Need (CMN) for certain types of Durable Medical Equipment (DME) in order to have an audit trail document required for a certain third party payor. In this example, the third party payor is government reimbursement under the Medicare program.

In order to streamline the presentation of the invention and its ability to improve the creation of an audit document for use in a reimbursement program for medical supplies or services, the application will step through the process, as it exists without the present invention.

FIGS. 1, 2A and 2B introduce a sample of a CMN form and the accompanying directions. CMN forms exist for various classes of durable medical equipment. This particular form is for motorized wheelchairs. To amplify the section nature of the form, FIG. 1 breaks the blank Form 100 into four major components: Part A 104, Part B 108, Part C 112, and Part D 116. FIGS. 2A and 2B are representative of instructions for filling out the various portions of FIG. 1.

FIG. 3 is used to illustrate the typical interaction flow between the various parties in the prior art process. The parties involved are the Patient 304; the Physician 308 and the Physician's Staff 312; the Supplier 316 and the Supplier's Records 320 which are maintained for audit purposes; and the Third Party Payor 324. Part of the process is to complete an instantiation of Form 100 for this particular interaction among the parties. This instantiation of the form is given the element number 101, with Parts A 105, B 109, C 113, and D 117.

The process starts with an Interaction 350 between Patient 304 and the Physician 308 and Staff 312. A Request 354 is sent from the Physician 308 and Physician's Staff 312 to a Supplier 316. This request is often verbal orders. Although others may fill out Part A 105 of the Form 101, typically the Supplier 316 interacts with Form 101 to fill out Part A 105 identifying the patient, supplier, physician etc. The Supplier 316 is the only party authorized to fill out Part C 112 identifying what is to be supplied and what the supplier will charge for each line item. The Step 358 of filling out Parts A 105 and C 113 typically happens before the Step 362 of supplying the Supplies 328 to the Patient 304 or the patient's caregivers. (Not shown). The Step 362 of supplying can be a sales transaction or a rental transaction in the case of certain medical equipment which can be reused by subsequent patients. Note that while the present description focuses on durable medical equipment, it can certainly be extended to consumables including disposable supplies. The periodic need for a reauthorization for a long-term supply of consumables can be handled by a re-certification of an existing certificate of medical need or by the processing of a new certificate of medical need.

After providing the Supplies 328, the Supplier 316 desires payment for the Supplies 328. However, under the existing payment system, the Patient 304 either does not pay anything, pays only a small co-pay, or does not pay until the payment amount from the Third Party Payor 324 has been received by the Supplier 320. Thus, the Supplier 316 must initiate a request for reimbursement from the Third Party Payor 324. The Third Party Payor 324 has set forth a requirement that it may not be given a request for reimbursement until after the instantiation of the CMN form 101 is completed. The instantiation of Form 101 has parts A 105, B 109, C 113 and D 117.

In Step 366, the Supplier 316 sends 366 the partially completed Form 101 to the Physician 308 and Physician's Staff 312 for completion. In Step 370, an authorized member of the Physician's Staff 312 will complete Part B 109. After Step 370, in Step 374, the Physician 308 reviews the information in Parts A 105, B 109, and C 113, then signs and dates the Form 101 to indicate authorization for Supplies 328 to Patient 304 by Supplier 316. This is a critical step in the prior art process as the Physician's signature indicates several important items. The signature represents that the Physician 308 was correctly identified by address, UPIN etc. in Part A 105. The Signature is also a representation that the entire form including the portions filled out by the supplier was completed before the physician signed the form. Finally, the Physician's signature is a representation that the information in Part B 109 relating to medical necessity is true, accurate, and complete to the best of the physician's knowledge. The Third Party Payor 324 holds the physician responsible for any purposeful false statements or signatures given in reckless disregard for the truth. The Third Party Payor 324 may disallow the use of signature and date stamps that are commonly used in medical practices as these devices can be accessed by others in the office. Similarly, concern for the potential to pass off forged documents through a faxed copy causes some third party payors to disallow the use of facsimile copies, thus incurring further delay.

In Step 378, completed Form 101 is sent back to Supplier 316. Upon receipt of a properly completed Form 101, the Supplier 316 sends a Request for Reimbursement 332 to Third Party Payor 324 and places the completed Form 101 in the Supplier's Records 320.

In Step 386, the Third Party Payor 324 sends payment 336 through check or electronic transfer to Supplier 316 in response to the Request for Reimbursement 332.

In Step 390, the Third Party Payor 324 periodically audits all or a portion of the Supplier Records 320. The audits may be performed by a party acting in behalf of the Third Party Payor, such as the audit services performed by DME Regional Carriers (“DMERCs”) (not shown in FIG. 3).

As evident from the above discussion, there is much delay between the provision of supplies 328 and the receipt of payment 336. The delays can be extensive, since the Physician 308 and Physician's Staff 312 often have many demands on their time which lead them to neglect the task of filling out Form 101. Thus, Supplier 316 must continue to ask the Physician 308 and or Physician's Staff 312 to complete a large queue of partially completed Forms 101. Despite efforts by suppliers to track and remind physicians to return forms, Suppliers find that it is often several weeks after the supplies are sent out before the Supplier 316 has the documentation needed before filing a request for Request for Reimbursement 332 from the Third Party Payor 324.

A DME supplier 316 currently utilizing a paper-based system will create a form either from an enterprise-based data management system or fill out a paper pre-printed form with a word processor application. They will then take the paper-generated form and either mail or hand deliver it to the physician's office. In the case where clinical input other than a physician is needed, they will seek out a nurse, a physical therapist, a respiratory therapist, etc. for their needed input by mail or courier. This process often takes up to 50-60 days to accomplish depending upon the workload and the priority that this document receives in the clinician's overview process. Activity based cost management estimates put this process at 20-25 dollars per document to process. Extended account receivables add 2-3 dollars per 30-day cycle. If you compare this to an average reimbursement for durable medical equipment rentals at $150 it becomes readily apparent that the processing of these forms entail a significant portion of the cost of doing business for the DME.

A separate problem with the prior art is that the current system does not actually check to see if the Physicians 308 are signing forms before the Physician's Staff 312 or the supplier completes the rest of the form. The current system does not actually know if the forms are backdated and filed with Supplier's records with a date matching the date the Request for Reimbursement 332 was sent to the Third Party Payor 332 since audits are done infrequently due to the need to travel to the site of the supplier's records.

A less crucial but realistic downside of the prior art use of preprinted forms is the time lags and waste associated with printing and distributing the approved forms for all the different types of documentation to show justification for all the different types of supplies. The end users must maintain an adequate inventory of a myriad of forms and must be able to effectively purge all unused copies of the form when a new revision of the form is mandated by the third party payor. The problem is magnified when the various third party payors require different forms for the same supplies.

One possible solution is to use existing systems to convey the partially completed form electronically from the supplier to the physician and back again. Most, if not all physician offices have computer equipment and could be equipped with communication equipment to allow the transfer over a modem or through a communications network such as the Internet, a Local Area Network, or Wide Area Network. The physician's office would need software to receive, read, edit, and affix a signature to the various instances of the Form 101. This sort of solution would reduce some of the time delays involved with the actual movement of the physical form, and allow the form to be sent without being physically lost in a pile of other papers (and resent if necessary).

The problem of this possible solution is that the provision of medical services occurs within a highly regulated environment. In order to avoid favoritism based on suppliers providing computer equipment or software to physician offices in return for referrals, there are limits on the ability of suppliers to provide communication equipment, storage devices, terminals, or software to physician's offices. A second problem arises under the various regulations concerning privacy of medical records. Thus, under regulatory schemes such as the authorized United States law under HPAA (Health Insurance Portability and Accountability Act of 1996), there are regulations to protect electronic medical records from unauthorized access or modification. As is well known in the art, read-only electronic records cannot be modified. Electronic records that can be modified make it difficult for a sequence of authors of portions of the document to be held accountable for their entries to the document.

For the convenience of the reader, various acronyms and other terms used in the field of this invention are defined at the end of the specification in a glossary. Other terms used by the applicant to define the operation of the inventive system are defined throughout the specification. For the further convenience of the reader, applicant has added a number of topic headings to make the internal organization of this specification apparent and to facilitate location of certain discussions. These topic headings are merely convenient aids and not limitations on the text found within that particular topic.

In order to promote clarity in the description, common terminology for components is used. The use of a specific term for a component suitable for carrying out some purpose within the disclosed invention should be construed as including all technical equivalents which operate to achieve the same purpose, whether or not the internal operation of the named component and the alternative component use the same principles. The use of such specificity to provide clarity should not be misconstrued as limiting the scope of the disclosure to the named component unless the limitation is made explicit in the description or the claims that follow.

The present description incorporates by reference the portions of the TRAC Medical, Inc. document titled “Building a Common-Sense Home Healthcare Secure Internet Strategy” as provided with the present application in appended pages A1-A22. This incorporated material provides additional details of a particular use of the present invention and is not to be taken as a restriction of scope of the present invention to the extent that the narrow scope is inconsistent with the text of the present application.

### SUMMARY OF AND OBJECTS OF THE INVENTION

The present invention addresses the need to expedite the completion of documentation supporting healthcare transactions while simultaneously complying with security and access regulations.

Unlike the prior art solution of sending either a physical form or an electronic form from one location to another, in the present invention, the form stays in a secured environment and is manipulated remotely by those who are authorized to do so. The present invention not only limits access to those who are authorized but further restricts access to those who provide credentials to prove their identity in addition to their authorization. The present invention limits those providing credentials and authorization to just the specific parts of specific instances of the forms. The system is further improved by the tracking of all modifications to the instances of the form. The modifications are tracked so as to record what was changed, when was it changed, and who was the credentialed authorized party that made the changes.

### OVERVIEW OF THE DISCLOSURE OF A PARTICULAR EMBODIMENT OF THE INVENTION

The eCMN Management System entails the use of a secure Web server that assures confidentiality and integrity of supporting healthcare documentation sent between home medical equipment suppliers and physician and/or supporting clinical staff. The secure web server is designed with firewall and encryption/decryption capability for presentation of Certificate for Medical Necessity to the appropriate physician or referring home health agency or supporting clinical personnel. Upon determination that the patient is in need of a medical device, a request by the DME supplier for certification is transmitted to the patient's physician via an e-mail system. Interface with a home health agency or supporting clinical personnel may be required for proper clinical information to be included in documentation presented to the physician. Population of the form is a secure sectionalized hierarchical format whereby users are credentialed for access and data entry functions.

The design of the system allows presentation to all parties (HME, HHA, clinical support personnel and physician) involved in the certification process. This allows the certification request process to originate from any of these entities with the ultimate signatory process residing with the physician. The prescribing physician in accordance with HCFA standards determines certification of medical necessity when presented with a request to review. Access for entry of clinical data and electronic signature is accomplished by application of the digital certificate issued from an approved authenticating authority. The signature is affixed to the document and the database may be audited by a third party intermediary for integrity and authenticity. This process assures that medical necessity forms have not been altered or augmented without the explicit consent of the prescribing physician. Treatment review (re-certification and change orders) may be updated via the electronic format as need indicates.

Benefits of the system include a high degree of document integrity and audit capability, as well as the ability to dramatically improve activity based cost management measurements.

It is an object of the present invention to provide a solution to the problem set forth above without requiring the installation, maintenance, and training of client side hardware or software beyond standardized credentialing and signature tools.

These and other advantages of the present invention are apparent from the detailed description that follows.

### BRIEF DESCRIPTION OF THE DRAWINGS

FIGS. 1, 2A and 2B introduce a sample of a CMN form and the accompanying directions.

FIG. 3 is used to illustrate the typical interaction flow between the various parties in the prior art process.

FIG. 4 is a system layout of the present invention in contrast between the prior art process shown in FIG. 3.

FIG. 5 is a partial diagram of an access device 500 showing the components relevant to the present invention.

FIG. 6 is a chart that highlights the reduction in process steps from the prior art solutions to the process of the present invention.

### DETAILED DESCRIPTION OF THE DISCLOSED EMBODIMENT

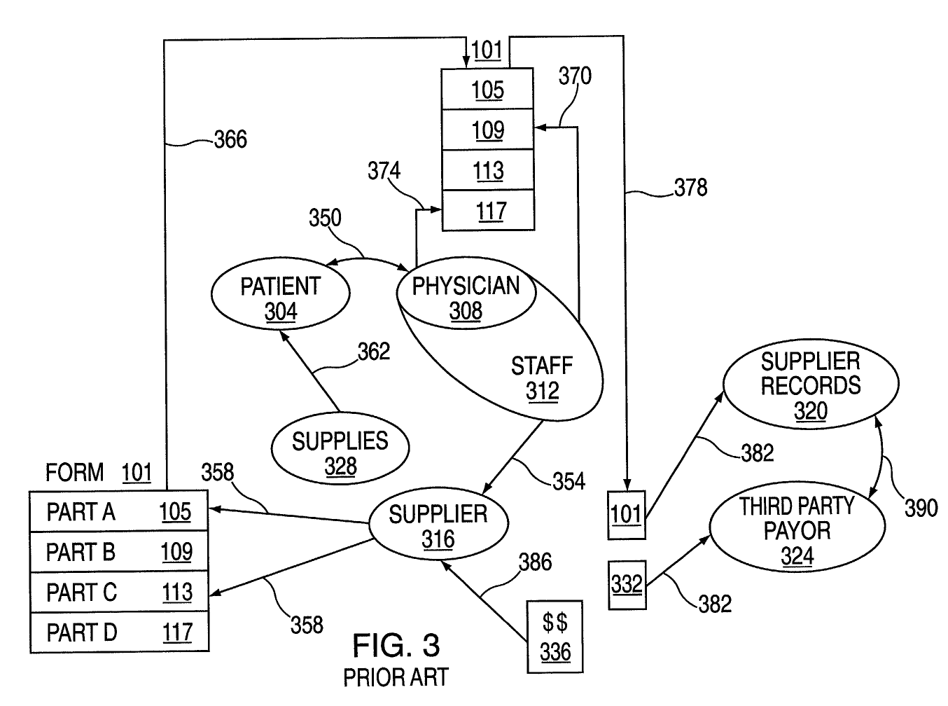

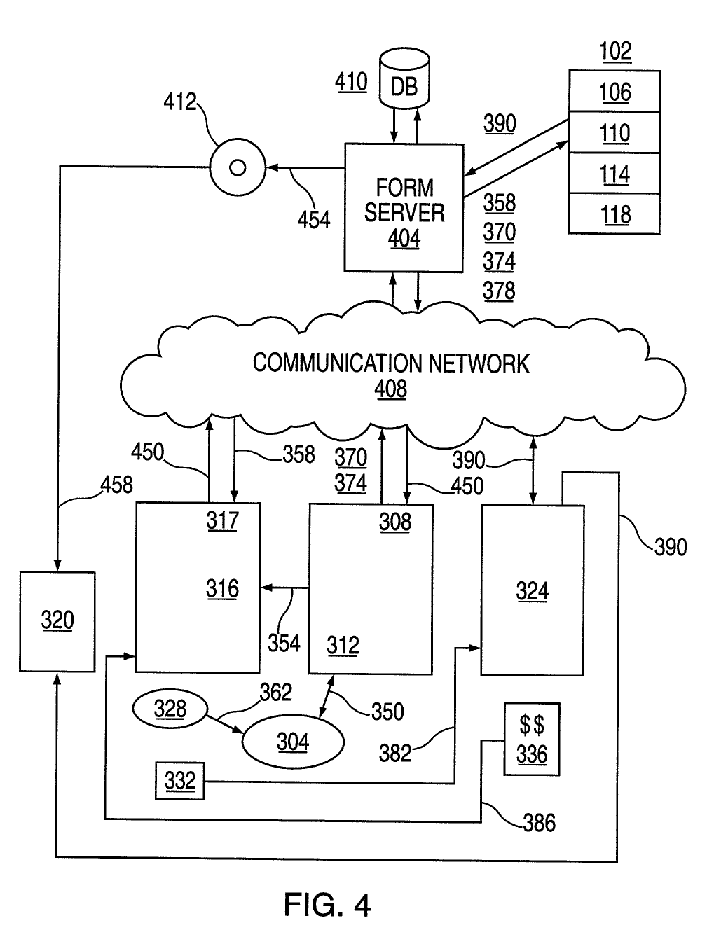

Moving now to FIG. 4, the system layout of the present invention is set forth. Although all the pieces from FIG. 3 are present in FIG. 4, the process is significantly different. Before getting to the details, one can note that all of the interactions with the instance of the e-form 102 are done remotely. Thus, Supplier 316, Physician 308, Physician's Staff 312, and Third Party Payor 324 all access the e-Form 102 through a Form Server 404 across a Communications Network 408.

Like the prior art process shown in FIG. 3, FIG. 4 illustrates a process that starts with the Interaction 350 between Patient 304 and the Physician 308 and Physician's Staff 312. The Request for Reimbursement 354 for supplies is sent from the Physician 308 and Physician's Staff 312 to a Supplier 316.

In keeping with the present invention, the Supplier 316 does not reach for one of the preprinted forms but rather accesses a form template on a Form Server 404.

Access for the Supplier 316 and other users of the system is through an access device such as a computer workstation or like device.

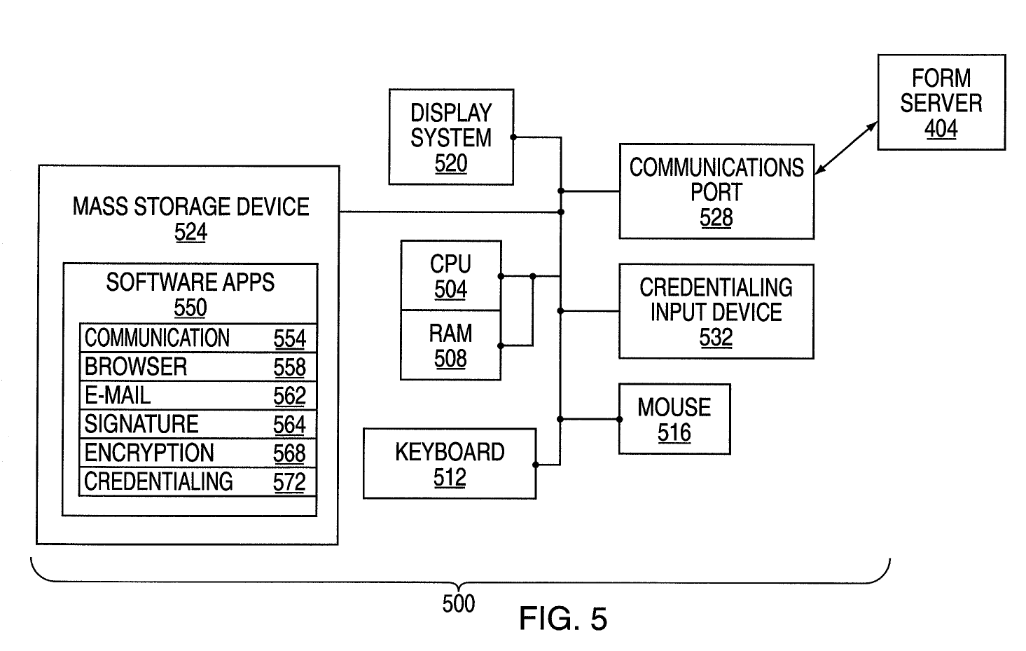

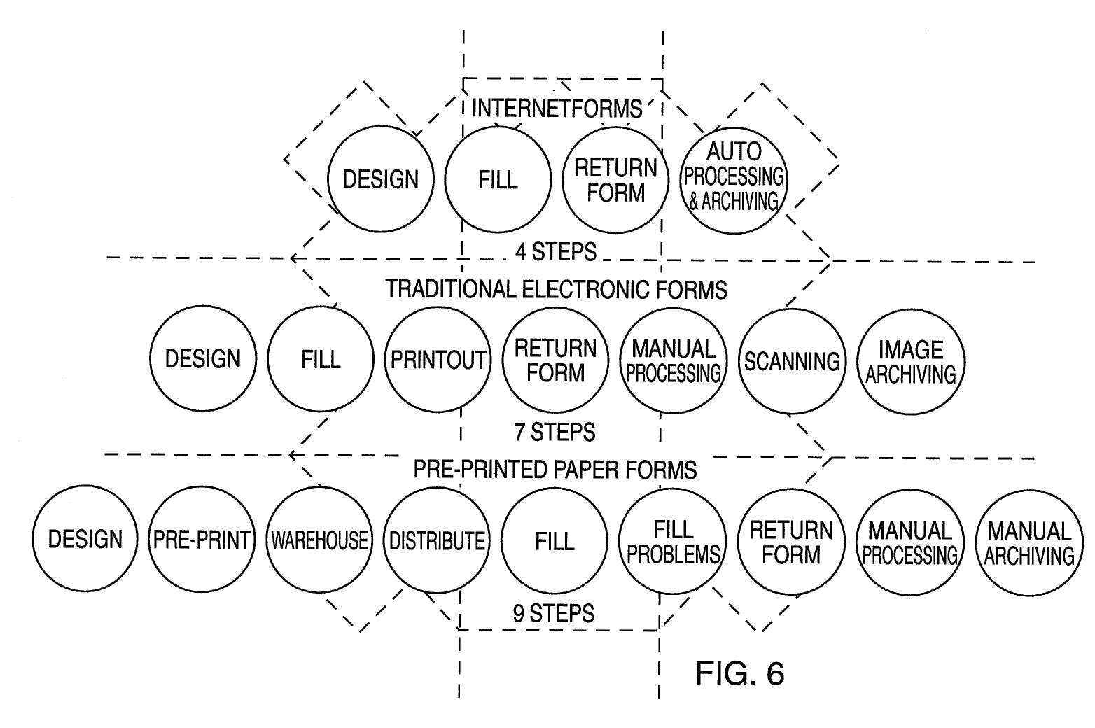

Turning now to FIG. 5, an access device 500 is shown with the components relevant to describing the present invention. As this description is for the purposes of explaining the present invention, it is not necessary to go into great detail on the interaction among the components mentioned, and this description will list the many ancillary hardware and software components necessary for the operation of such a workstation as that information is readily available and would only serve to detract focus from the present invention.

At a high level of abstraction, the Access Device 500 is comprised of a CPU 504, RAM 508, a Keyboard 512, an optional input device such as a pointing device known as a Mouse 516, a Display System 520 comprised of display hardware, display memory, and display driver software; a Mass Storage Device 524 for storing data and a plurality of software applications 550. The software applications that are frequently found on an Access Device 500 include Communications Software 554 to enable communications between the Access Device 500 and other remote devices through a Communication Port 528. In a physician's office, the Communications Software 554 (not shown here) and Communication Port may be a network interface card and necessary software to allow the Access

Device 500 to communicate with other devices on a local area network. The local area network would include one or more shared communication ports to provide access to devices not physically connected to the local area network.

Thus, either directly from the Access Device 500 or indirectly from equipment shared by the Access Device 500, the Access Device 500 may communicate with remote devices across a communication network such as a telephone network, a computer communications network such as the Internet, or a private communication network. The present invention will work with a variety of communication devices (such as telephone modems, cable modems, fiber optic moderns, wireless links etc.). A slow communication link will impact the ability to receive and transmit data but that is not critical to the use of the present invention.

Many workstations will have one or more Signature Applications 564 which allow a person to affix a digital signature to a document. There are a variety of signature tools known in the art. A preferred tool for the present invention uses digital certificates from MEDePASS, Inc. of San Francisco, Calif., a for profit subsidiary of the California Medical Association. The process for providing digital certificates to authorized users is outlined in the subsequent section.

Credentialing Authority.

In order for the electronic CMN process to be a viable option for third party payors, such as HCFA, there must be a system in place for the verification of physician credentials and the authentication of physician digital signatures. Additionally, there must also be a system in place to verify credentials and issue certificates to DME suppliers and non-physician clinical staff.

a. MEDePass, Inc. has agreed to serve as the Certificate Authority (“CA”) for physician signatures with the assistance of the state medical boards; and

b. TracMed, Inc. will act as the credentialing authority for DME suppliers, non-physician clinical staff, and home health agencies. TracMed, Inc. has established a credentialing process to ensure that only certificates belonging to valid personnel may be used to gain access to our systems.

A MEDePass Affiliated Certificate Authority (CA) established for each state and healthcare license type issues MEDePass certificates. For state physician CA, the following types of organizations are preferred: the state medical society, the state medical license board, or a healthcare organization that is governed predominately by state licensed physicians and which has contact with a majority of the state's physicians. Medical Societies are the natural candidate for the state physician CA due to their pre-existing knowledge of the physicians in their state and to their in-house processes for validating physician licensure, supporting physician business and practice standards, communicating with physicians and educating them about industry concerns and practices.

MEDePass Physician Certificate Application and Approval

A physician must obtain, complete and sign a MEDePass Certificate Application as the first step toward obtaining a MEDePass Certificate. There are two ways for this to happen. First, an authorized person acting on behalf of the CA gives the physician a paper copy of the application.

The physician completes the application, signs it and returns it to the CA. Second, a colleague, who is a MEDePass subscriber, refers the physician by sending a signed email message to the CA giving the physician's name and a valid email address. The CA emails an electronic copy of the application to the referred physician who then prints the application, completes, signs and returns it to the CA. Once the CA has received a signed application, it will verify the physician's license status and approve or deny the application. If the application is approved, the CA emails the physician a secure pin, which in combination with the application serial number is used to authenticate the physician to the MEDePass issuing application. The email message also contains instructions for how the physician is to access the issuing application. Once the issuing application has authenticated the physician, it instructs the physician's browser to generate the private key pair and pass the public key to the application. The application then embeds the public key and the physician's license information verified from the certificate application into the MEDePass certificate and passes the certificate to the physician's browser.

The process described above requires the CA to verify the following information:

Physician's license name;

State license board;

License number;

License expiration date;

License status; and

Email address.

In most cases, the physician license information is verified by direct reference to the State Licensing Board while the physician's email address is verified by prior knowledge and interaction—either by the CA or by the colleague. Having a valid email address is a vital part of ensuring that certificates are issued appropriately.

Standard Procedures to Issue MEDePass Certificates

The following two methods are standard procedures for issuing MEDePass certificates.

Colleague Referral

The MEDePass Colleague Referral procedure was developed to take advantage of the first-hand knowledge that physicians have about their colleagues and to make it difficult for non-physicians to obtain a certificate application. A physician already holding a valid MEDePass certificate must first refer all MEDePass subscribers. The procedure starts by issuing the initial MEDePass certificates to physicians personally known to the CA. These first subscribers can then refer their colleagues, who in turn can then refer additional colleagues. The Colleague Referral procedure allows for a simple yet rapid distribution of MEDePass certificates and at the same time, acts to close off access to the MEDePass system by non-physicians. To increase the reliability of the issuing process, the referring colleague is sent an acknowledgement of the referral and a copy of the physician's certificate when it is issued. Additionally, based on a statistical sampling process, all certificates are subject to out-of-band verification.

Group Referral

The group referral procedure is designed to simplify the referral operation for medical groups, hospital systems, health plans, or other recognized healthcare organizations. The organization appoints a physician, usually a medical director, to obtain a MEDePass Certificate via the standard Colleague Referral. The Medical Director can then request the CA to send certificate applications to a group of the organization's physicians. The Medical Director must provide the physicians' name, license number, authorized email address and confirm that all physicians on the group referral have been properly accredited by the organization. Therefore, the group referral option is only available to organizations that credential physicians. The Medical Director becomes the referring colleague for each physician on the list. Once the CA receives the signed list, it emails a certificate application to each physician and processes the application as previously described. The medical director receives notification and a copy of the MEDePass certificate for each physician once it has been issued.

Credentialing Process for Non-Physician eCMN Participants

Since DME suppliers can initiate CMNs and non-physician clinical staff and Home Health Agency (“HHA”) personnel can be authorized to complete Section B of a CMN, it is appropriate that there be a credentialing process for these personnel to obtain digital certificates so that they may have authenticated and secure access to the proposed electronic CMN documentation and associated processes. TracMed, Inc. recognizes this need and has defined a credentialing mechanism for non-physicians to provide authenticated access to the proposed electronic CMN documentation, and for the support of associated processes such as the exchange of encrypted mail between DME suppliers and physicians, or between HHA personnel and the physician's staff. The availability of such a trusted credentialing process will additionally provide benefits to the evolving business-to-business relationship between providers and manufacturers. TracMed, Inc. has established a credentialing model for demonstrating a technical solution for such purposes. The inherent theme of colleague referral or centric-based trust entities is the model that TracMed, Inc. believes best demonstrates adherence with the proposed rules under HIPAA. The purpose of this credentialing process will be to provide an out-of-band trusted credentialing process to enable the use within the healthcare industry of class 1 digital certificates issued by reliable CA's such as Verisign. TracMed, Inc. has defined a credentialing mechanism for DME suppliers, non-physician staff members authorized access to eCMNs by the attending physician, and Home Health Agency (“HHA”) personnel directly involved in the patient's care.

Issuing Certificates to Durable Medical Equipment Providers

For purposes of credentialing the DME will designate an authorized representative as their Security Officer. The Security Officer will obtain a digital certificate from a trusted CA (the current list of which will be available from TracMed, Inc. upon request) and will copy the full issuer and subject distinguished names from his certificate onto the TracMed, Inc. Service Contract, which must then be completed and executed by the President, Owner, or other authorized representative of the company. It will then be the subsequent responsibility of the Security Officer to authorize and revoke any additional credentials that will be authorized to represent the company. All durable medical equipment suppliers participating will be required to sign a memorandum of understanding that will define the corporate role and responsibility of attestation of employee identities. TracMed, Inc. will review the signed application, verify that the DME Company is approved to conduct business with the Medicare system and approve the application.

Upon acceptance of the Security Officer's credentials, additional employees of the DME may gain access to the eCMN server by obtaining certificates from a trusted CA. The Security Officer will digitally sign (using his trusted certificate key) an electronic application that will contain the full issuer and subject distinguished names present on the employee's certificate. Upon receipt and verification of this application TracMed, Inc. will grant access to its servers to the holder of the associated certificate's key.

Revocation of an employee's access to the eCMN servers due to factors such as termination of employment or change in job status is the responsibility of the designated Security Officer, who will notify TracMed, Inc. of this change in status at the earliest possible date and in any case no later than the close of the next business day after the change in employee status. If the DME Company's Security Officer changes, TracMed, Inc. should be notified immediately and the DME should immediately appoint another Security Officer using the process outlined above. If there is a key compromise, TracMed, Inc. should be notified immediately so that we can revoke that key's access to the system.

Issuing Certificates to Non-Physician Clinical Staff

One plan for issuing certificates uses the physician as the Security Officer. The physician will already be enrolled in the eCMN system and possess a valid MEDePass digital certificate. As such, there has already been an out-of-band trusted relationship established with the physician, so it is not necessary to repeat this process. The physician will be provided with a clear description of the implications of granting access to the physician's eCMNs to the physician's staff members.

Upon acceptance of the physician's credentials, authorized employees may gain access to the eCMN server by obtaining certificates from a trusted CA. The physician will digitally sign (using his trusted MEDePass key) an electronic application that will contain the full issuer and subject distinguished names present on the employee's certificate. Upon receipt and verification of this application TracMed, Inc. will grant access to its servers to the holder of the associated certificate's key.

Revocation of an employee's access to the eCMN servers due to factors such as termination of employment or change in job status is the responsibility of the designated physician, who will notify TracMed, Inc. of this change in status at the earliest possible date and in any case no later than the close of the next business day after the change in employee status. If the physician's certificate should become invalid for any reason, then all of the employee certificates that were granted access to the eCMN system via the physician's certificate will no longer be granted access under that certificate. If there is a key compromise, TracMed, Inc. should be notified immediately so that we can revoke that key's access to the system.

Issuing Certificates to Home Health Agency Personnel

The HHA will designate an authorized representative as their Security Officer. The Security Officer will obtain a digital certificate from a trusted CA (the current list of which will be available from TracMed, Inc. upon request) and will copy the full issuer and subject distinguished names from his certificate onto the TracMed, Inc. Service Contract, which must then be completed and executed by the President, Owner, or other authorized representative of the company. It will be the responsibility of the Security Officer to attest to the validity of the credentials that will be authorized to represent the company. All HHAs participating will be required to sign a memorandum of understanding that will define the corporate role and responsibility of attestation of employee identities. TracMed, Inc. will review the signed application, verify that the HHA is approved to conduct business with the Medicare system and approve the application.

Upon acceptance of the Security Officer's credentials, additional employees of the HHA may gain access to the eCMN server by obtaining certificates from a trusted CA. The Security Officer will digitally sign (using his trusted certificate key) an electronic application that will contain the full issuer and subject distinguished names present on the employee's certificate. Upon receipt and verification of this application TracMed, Inc. will grant access to its servers to the holder of the associated certificate's key. The attending physician will authorize access to their patients' eCMNS to specific HHAs, and those HHA employees will only be granted access to those eCMNs for which the physician has designated.

Many workstations have at least one Encryption Application 568. Encryption application tools allow for added security on messages sent across communication networks. One popular tool is the Public/Private Key Encryption known as PKI. The preferred embodiment of the present invention uses a standard commercial implementation of PKI, or some variation thereof, and is implemented in the Secure Socket Layer (SSL) Version 3.0 available as open source software (SSL is sometimes referenced as Transport Layer Security (TLS)) with 128/1024 Encryption.

In order to comport with regulations regarding maintaining privacy and security of patient's medical records, many workstations in a medical environment have a Credentialing Input Device 532. These devices range from those that seek biometric input to confirm identity, to those devices that require an ID badge. The devices requiring an ID badge may simply require that the badge be within a short wireless range of the credentialing input device, or may require a card swipe as is common for charge or debit cards. A Credentialing Input Device 532 is not required if the system is set up to receive proof of identity by the submission of passwords or PIN numbers (personal identification numbers). To the extent that a Credentialing Input Device 532 is used, it is likely to have some software loaded on Mass Storage Device 524, shown here as Credentialing Application 572.

Returning now to FIG. 4, the Supplier 316 working at Access Device 500 (not shown here) connects to the Form Server 404 across a communications network. The Form Server 404 receives both the prescribed information uniquely identifying the specific Supplier 316 and the Supplier Employee 317 accessing the Form Server 404, but also one of the one-or-more prescribed forms of credentialing to indicate that the user is actually the authorized party. As indicated above, the credentialing process is any of the processes satisfactory to the third party payor such as biometrics, possession of a badge or key, or knowledge of a password or PIN, or other credentialing process.

After proving status as an authorized credentialed user, the Supplier employee 317 is allowed to view previously started or completed instances of the various forms that list the employer of Supplier employee 317 as Supplier 316. The system could allow the Supplier 316 to limit employee access to a subset of the total form instances for that Supplier 316, such as limiting access to form instances completed by that specific employee or by that employee's department. It is also possible that some employees may be given permission to view-only and without permission to alter. This view only status may be appropriate for an employee in the shipping area that may need only to view the forms (or portions of the forms) but not alter the information.

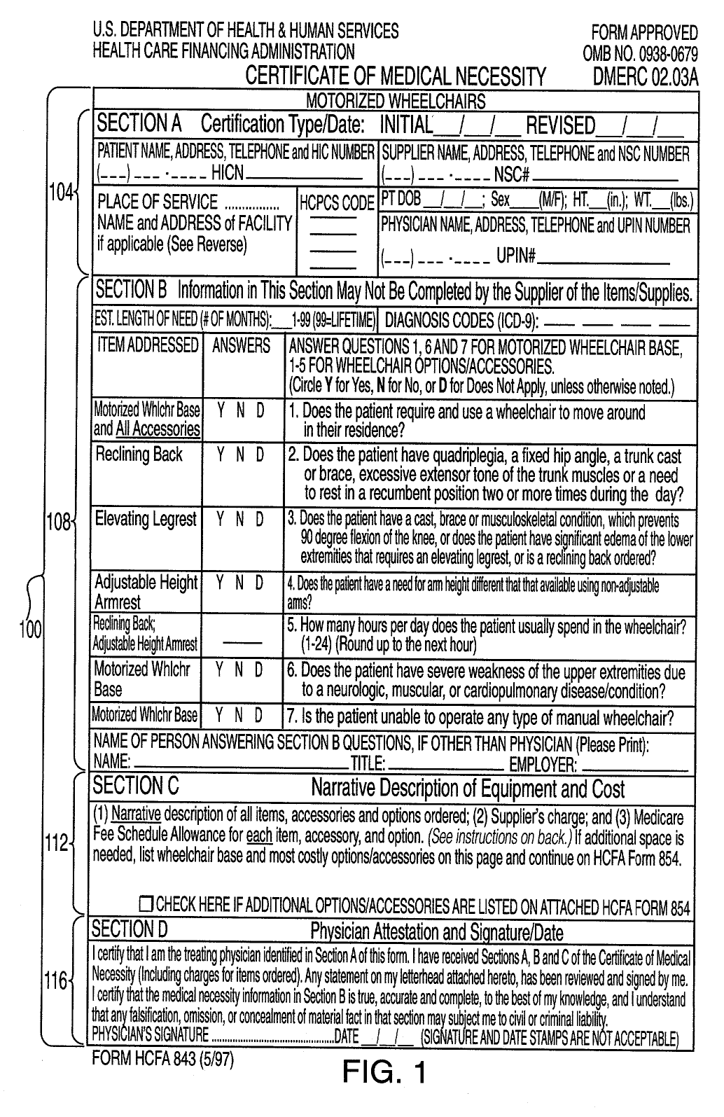

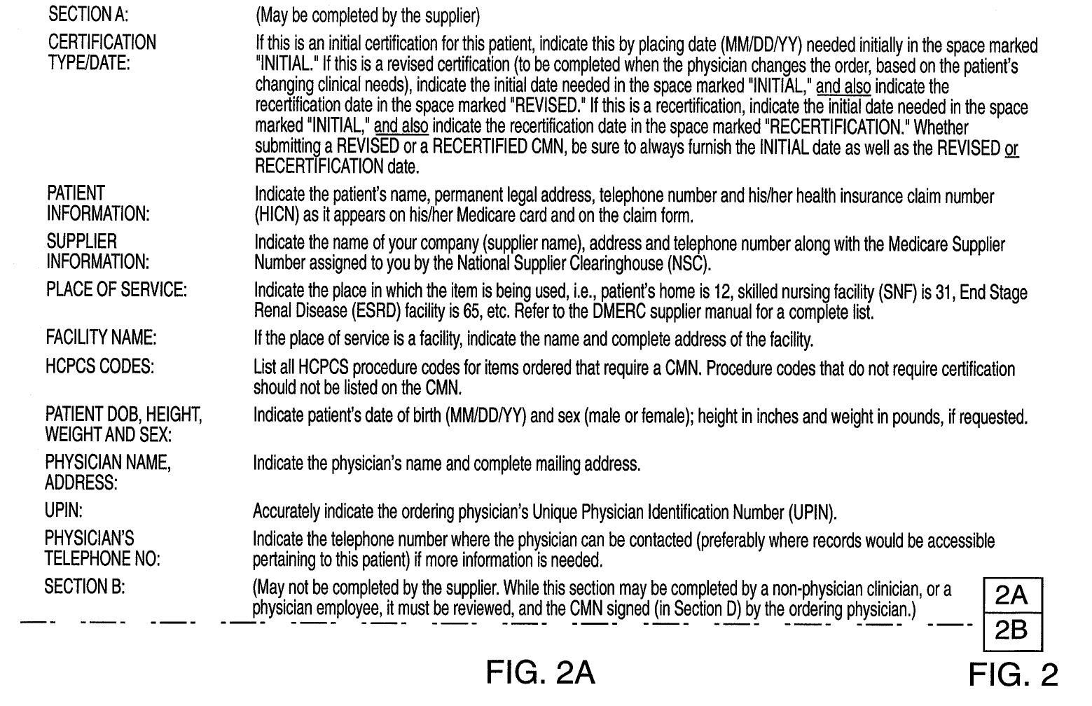

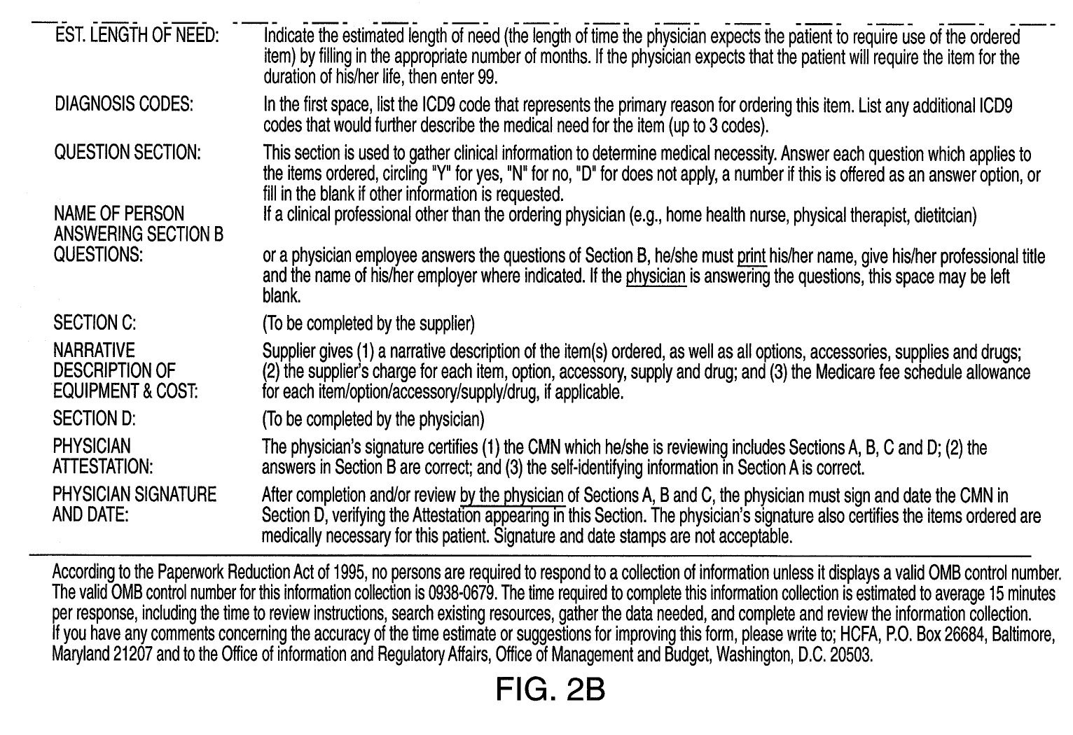

In this example, the Supplier Employee 317 is initiating a new instance of the form set forth in FIGS. 1 and 2. Supplier Employee 317 interacts with an image of the form on the Access Device 500. To distinguish the instance of the Paper Form 101, this image of a form is given element number 102 (with 106, 110, 14, and 118 for parts A, B, C, and D.) As the image of the form is altered on the Access Device 500, the information added, deleted, or changed by the Supplier Employee 317 is transmitted across the communication network to a database 410 associated with Form Server 404. The database 410 records the changes made, who made the changes, how the user was credentialed, and the date/time of the change.

As with the prior art process, the Supplier 316 through its Supplier Employee 317 provides the information identifying the patient and physician. However, unlike the prior art process, the information goes to the database 410 and appears on the image of the form. Advantageously, the system can fill in the supplier address and identification information based on knowing who the Supplier Employee 317 is and who that employee works for. After completing Part A 106 the Supplier Employee 317 completes Part C 114 identifying what is to be supplied and what the supplier will charge for each line item. The Act 358 of filling out Parts A and C typically happens after the Act 362 of supplying the Supplies 328 to the Patient 304 or the patient's caregivers, as the supplies are typically provided based on an oral order. The act of supplying can be a sales transaction or a rental transaction in the case of certain medical equipment that can be reused by subsequent patients.

Rather than sending a physical partially completed form, the Supplier Employee 317 performs the step of sending an electronic notice (not shown) such as an email message to the requesting Physician 308. Upon receipt of the electronic notice or on some periodic basis, the Physician 308 or an authorized member of the Physician's Staff 312 processes the queue of partially complete forms awaiting Part B 110 to be completed. This step can be accomplished by the Physician 308 double clicking on a URL in the email from the Supplier Employee 317, where the double clicking on the URL causes the browser application to go to that URL and the URL points to the Form Server 404. The other way of accessing the partially completed form is for the Physician 308 or authorized member of the Physician's Staff 312 to access the Form Server 404 using an access device 500. As described above, the user would provide his or her identity and credentials. The system could partially fill in information about the person completing Part B based on the information that the Form Server 404 knows about the credentialed user.

The user would then be allowed to view and edit partially completed instances of the Form 102 where authorized. The Form Server 404 would present the partially completed forms list that a particular Physician 308 in Part A 106. The Physician 308 would have previously listed the access rights of the Physician's Staff 312 to view forms and to complete Part B 110. As in the case of input from the Supplier Employee 317, the input is stored in the Database 410 along with information on the user providing the input, the date and the time of the input.

After an authorized credentialed user completes Step 370 by completing Part B 110, in step 374, the Physician 308 reviews the information in Parts 106, 110, and 114 while using an access device 500 to view an image of Form 102 populated with information from Database 410. As described above, the Physician 308 is only given access to the form upon presentation of authorization and credentials. The Physician 308 may view and sign any instance of the form that designates that Physician 308 in Part A of the instance of the form. Since it is the Physician who must sign and be responsible for the contents of the form, the system may be configured to allow the Physician to make corrections to data fields in Part A, Part B, and possibly Part C. However, some fields such as the line item price may not be open to alteration by the Physician.

Upon approval of the information in the instance of the form, the Physician indicates to the Access Device 500 that the Physician agrees to “sign” the instance of the form. The Signature Application 564 supplies the digital information to the Form Server 404 which then bundles the data to populate the instance of the form with the digital signature to create a completed instance of the form. As before, the system may be configured to partially complete Part D with information about the Physician 308 since the system is satisfied that the credentialed user is indeed the Physician known to the Form Server 404.

The Physician 308 may access previously signed instances of the form to correct or modify the data. To do this the Physician 308 indicates via the access device 500 the desire to unlock the signed instance of the form. After making the changes, the Physician must re-sign the form. As noted above, the transaction history of the changes made to the instance of the form are stored in Database 410.

Note that the Physician 308 may access the Form Server 404 from any location where the physician has both an Access Device 500 and the means to be credentialed. This means that a Physician 308 who works at one location two days a week and a second location three days a week, performs rounds at two hospitals and does some office work at a home office, may be able to work off a queue of many instances of forms from any location where the Physician 308 has available time. Under the old paperbound system, it is quite likely that the forms needing review and signature would not be where the physician is idle. The present invention conserves physician time by requiring the Form Instance 102 to be properly completed before it is queued up for Part D review and approval. The prior paper based system was apt to provide partially completed forms which were incomplete in some way or were illegible. The system can be adapted to help check the validity of entered code numbers such as HCPCS codes, diagnosis codes, etc., so that the codes match the appropriate value and that invalid values are not accepted. The amount of form checking and/or assistance to users filling out the form is a decision for the operators of the Form Server 404 based on time, cost, and the existence of regulatory prohibitions. Under the highly regulated environment, some time saving features cannot be provided as they would be prohibited as illegal inducements.

In Step 378, rather than sending the original signed paper copy of the Form 101, an email notification is sent to the Supplier 316. Either through double-clicking on a URL in the email or by accessing the Form Server 404, a Supplier Employee 317 notes the receipt of a signed instance of the Form 102 and initiates the Request for Reimbursement 332 to Third Party Payor 324. For the short term, the completed signed instance of the form 102 remains on the Form Server 404 although the Supplier 316 may of course optionally place a printout of an image of the completed form in the Supplier's Records 320.

A Supplier 316 inquiring on the status of an incomplete instance of the Form 102 may view the form through an Access Device 500 by an authorized credentialed user. This visibility allows the actual status of a form to be quickly determined, as opposed to the inability to track paper Forms 101 once they are in the physician's place of business.

As in the prior art process, in Step 386, the Third Party Payor 324 sends Payment 336 through check or electronic transfer to Supplier 316 in response to the Request for Reimbursement 332.

In Step 390, the Third Party Payor 324 or a party acting on behalf of the Third Party Payor 324 periodically audits all or a portion of the records for Supplier 316. However, distinctive from the need to visit the Supplier's Records 320, audits can be performed periodically against the documentation for Supplier 316 to support claims for reimbursement to a particular Third Party Payor 324. (If more than one Third Party Payor 324, allow use of the same form template, the identity of the Third Party Payor by unique identifying code would be included in Part A 106 of the Form 102).

As described above, the Third Party Payor 324 may access the information on signed instances of forms as it is the Third Party Payor through an access device 500 which interfaces with the Form Server 404 to allow a credentialed authorized user to view images of various instances of the form.

A Third Party Payor 324 not wishing to use an Access Device 500 may use any authorized process to request a set of images directly from the operator of the Form Server 404. The images could be sent as printed material since it is less likely that the Form Service 404 would be colluding with any one supplier to submit false claims. The images could also be burnt to compact disk so that the Third Party Payor 324 receives the database records sufficient to populate the instances of forms for the requested time period and supplier. The provision of the read-only copy of the data base records would allow the third party payor to see the sequence of inputs and deletions that led to the completed form.

In the event that operators of the Form Server 404 do not wish to retain completed forms for the entire period of possible audit by third party payor (which may be 7 years or more), the operators of the Form Server 404 may institute a process whereby compact discs are periodically prepared (Step 454) with the database records for a given supplier for a given time period and sent (Step 458) to the Supplier Records 320 for the Supplier to check for completeness. After a designated time sufficient for the Supplier 316 to request new copies of any missing instances of forms, the original data base entries will be deleted from the Database 410 (deletion step not shown).

Alternate Embodiments

An extension of the present invention uses information from completed and signed Form 102 to partially populate the Request for Reimbursement 332. The partially populated request for reimbursement 332 could then be emailed to the Supplier 316 for completion and submission in paper or electronic form to Third Party Payor 324.

Scope of Patent

Those skilled in the art will recognize that the methods and apparatus of the present invention has many applications and that the present invention is not limited to the specific examples given to promote understanding of the present invention. Moreover, the scope of the present invention covers the range of variations, modifications, and substitutes for the system components described herein, as would be known to those of skill in the art.

The legal limitations of the scope of the claimed invention are set forth in the claims that follow and extend to cover their legal equivalents. Those unfamiliar with the legal tests for equivalency should consult a person registered to practice before the patent authority which granted this patent such as the United States Patent and Trademark Office or its counterpart.

Glossary of Selected Terms

Audit Document—This term includes both documents that are created and stored for use during audits and documents where a copy is passed through one or more steps of the reimbursement process to provide information to justify the request for reimbursement.

CMN—Certificate of Medical Need

DME—Durable Medical Equipment

DMERC—Durable Medical Equipment Regional Carriers

HIPAA—Health Insurance Portability and Accountability Act of 1996 and the various regulations to implement it. HIPAA covers many topics including various requirements to promote privacy of the patients with medical information in electronic form including many requirements relating to security and limitations on use.

HCFA—Healthcare Finance Administration

HCPCS #—A unique identifier

HIC number—a unique identifier for the patient

ICD-9—diagnosis codes to describe the patient's condition

Internet:—includes Internet2 and subsequent communication networks that replace or partially replace the Internet as a communication network

NSC—a unique identifier for the supplier by the National Supplier Clearinghouse

UPIN—Unique Physician Identification Number

XML—Extensible Mark-up Language

What is claimed is:

1. A method for processing a form document across a communications network comprising a first access device, a second access device, and a form server, the method comprising the steps of:
receiving at least one request for an operator of the first access device to process the form document;
determining whether the operator of the first access device is authorized to process the form document;
providing at least one image of the form document to be viewed by the operator of the first access device;
receiving at least one response from the operator of the first access device including information used to complete the form document;
determining whether the operator of the second access device is authorized to process the form document;
providing at least one image of the form document to be viewed by the operator of the second access device; and
receiving at least one response from the operator of the second access including information used to complete the form document.

2. The method of claim 1 wherein at least part of the information received from the operator of the first access device and at least part of the information received from the operator of the second access device associated are recorded in a database.

3. The method of claim 1 wherein the step of determining whether the operator of the first access device is authorized to process the form document includes receiving information to identify of the operator of the first access device.

4. The method of claim 3 wherein the information to identify the operator of the first access device includes a password.

5. The method of claim 3 wherein the information to identify the operator of the first access device includes information obtained from a credentialing input device.

6. The method of claim 3 wherein the step of determining whether the operator of the second access device is authorized to process the form document includes receiving information to identify the operator of the second access device.

7. The method of claim 6 wherein the information to identity the operator of the second access device includes a password.

8. The method of claim 6 wherein the information to identify the operator of the second access device includes information obtained from a second credentialing input device.

9. The method of claim 1 wherein the information received from the operator of the first access device includes a digital signature.

10. The method of claim 9 wherein the information received from the operator of the second access device includes a digital signature.

11. The method of claim 1 wherein the first access device includes at least one encryption application.

12. The method of claim 11 wherein the second access device includes at least one encryption application.

13. The method of claim 1 further including the steps of determining whether the information used to complete the form document received from the operator of the first access device is valid and whether the information used to complete the form document received from the operator of the second access device is valid.

14. The method of claim 1 wherein the form document has multiple sections and further including the steps of determining which sections of the form document the operator of the first access device is permitted to populate before receiving the at least one response from the operator of the first access device including information used to complete the form document and determining which sections of the form document the operator of the second access device is permitted to populate before receiving the at least one response from the operator of the second access device including information used to complete the form document.

15. The method of claim 1 wherein the form document has multiple sections and further including the steps of determining which sections of the form document the operator of the first access device is permitted to populate after receiving the at least one response from the operator of the first access device including information used to complete the form document and determining which sections of the form document the operator of the second access device is permitted to populate after receiving the at least one response from the operator of the second access device including information used to complete the form document.

16. The method of claim 1 wherein a date and time that the at least one response from the operator of the first access device including information used to complete the form document is received are recorded in a database.

17. The method of claim 16 wherein a date and time that the at least one response from the operator of the second access device including information used to complete the form document is received are recorded in a database.

18. The method of claim 12 wherein the form server includes firewall and encryption and decryption capability.

19. A method for processing an electronic form document across a communications network comprising a first access device, a second access device and a form server, the method comprising the steps of:
receiving at least one request requesting to process the form document through a first access device operated by a representative of a supplier of medical equipment, the at least one request requesting to process the form document through a first access device including information to uniquely identify the supplier and representative of the supplier;
providing the representative of the supplier with at least one image of the form document;
receiving information from the representative of the supplier including information used to complete the form document;
receiving at least one request requesting to process the form document through a second access device operated by a representative of a physician, the at least one request requesting to process the form document through a second access device including information to uniquely identify the physician and representative of the physician;
determining whether the at least one representative of the physician is authorized to view the form document and providing the representative of the physician with an image of the form document if the representative of the physician is authorized to view the form document; and
receiving information from the representative of the physician including information used to complete the form document.

20. The method of claim 19 wherein the at least one representative of the physician includes the physician.

21. The method of claim 20 further including of the step of receiving a digital signature from the physician.

22. The method of claim 21 wherein at least part of the information received from the representative of the supplier and at least part of the information received from the representative of the physician are recorded in a database after receiving the digital signature from the physician.

23. The method of claim 22 wherein the date and time that the digital signature from the physician is received are recorded in the database.

24. The method of claim 21 further including the steps:
receiving at least one additional request to process the form document by the at least one representative of a physician;
receiving additional information from the at least one representative of the physician used to complete the form document;
receiving an additional digital signature from the physician;
recording at least part of the additional information received from the representative of the physician in the database after receiving the additional digital signature from the physician.

25. The method of claim 24 wherein a first date and time that the digital signature from the physician is received are recorded in the database and wherein a second date and time that the additional digital signature from the physician is received are recorded in the database.

26. The method of claim 20 wherein the information uniquely identifying the representative of the supplier includes a password.

27. The method of claim 20 wherein at least part of the information uniquely identifying the representative of the supplier is determined from a credentialing input device.

28. The method of claim 26 wherein the information uniquely identifying the representative of the physician includes a password.

29. The method of claim 27 wherein at least part of the information uniquely identifying the representative of the physician is determined from a credentialing input device.

30. The method of claim 20 further comprising the steps of:
receiving at least one request to access the form document from the form server from a third access device operated by a representative of a third party payor, the at least one request from the third access device including information to uniquely identify the third party payor and representative of the third party payor;
determining whether the at least one representative of the physician is authorized to access the form document and providing the representative of the physician with the contents of the form document if the representative of the third party is authorized to access the form document.

31. The method of claim 20 further including the steps of determining which sections of the form document that the representative of the supplier is permitted to populate before receiving information from the representative of the supplier including information used to complete the form document and determining which sections of the form document that the representative of the physician is permitted to populate before receiving information from the representative of the physician including information used to complete the form document.

32. The method of claim 20 further including the steps of determining which sections of the form document that the representative of the supplier is permitted to populate after receiving information from the representative of the supplier including information used to complete the form document and determining which sections of the form document that the representative of the physician is permitted to populate after receiving information from the representative of the physician including information used to complete the form document.

33. A method for processing form documents across a communications network comprising a first access device, a second access device and a form server, the method comprising the steps of:
providing a physician with an application to process at least one of the form documents from the form server, verifying the physician's license status, determining whether the application should be approved and providing the physician with at least one key to access the at least one of the form documents from the form server if the application is approved; and
providing at least one representative of a supplier with a second application to process at least one of the form documents from the form server, determining whether the application should be approved and providing the at least one representative of the supplier with at least one key to access the at least one of the form documents from the form server if the application is approved.

34. The method of claim 33 further comprising the steps of:
receiving at least one request requesting to process one of the at least one of the form documents through a first access device operated by the at least one representative of a supplier, the at least one request requesting to process one of the at least one of the form documents through the first access device including information to uniquely identify the supplier and representative of the supplier;
determining whether the at least one representative of the supplier is authorized to process the form document and providing the representative of the supplier with an image of the form document;
receiving information from the at least one representative of the supplier including information used to complete the form document;
receiving at least one request requesting to process one of the at least one of the form documents through a second access device operated by the at least one representative of a physician, the at least one request requesting to process one of the at least one of the form documents through the second access device including information to uniquely identify the physician and representative of the physician;
determining whether the at least one representative of the physician is authorized to view the form document and providing the representative of the physician with an image of the form document; and
receiving information from the representative of the physician including information used to complete the form document.

35. A system for processing a multi-part form document comprising:
a first access device;
a second access device; and
a form server connected to the first access device and connected to the second access device over a communication network wherein the form server is operative with the first access device and second access device to:
determine if an operator of the first access device is authorized to populate at least one section of the multi-part form;
receive information used to populate the at least one section of the multi-part form from the first access device and store at least part of the information received from the first access device in at least one file;
determine if an operator of the second access device is authorized to populate at least one additional section of the multi-part form;
receive information used to populate the at least one additional section the multi-part form from the second access device and store at least part of the information received from the second access device in the at least one file.

36. The system of claim 35 wherein the form server is operative with the first access device to send information included in the multi-part form to the operator of the first access after receiving a request to process the multi-part form document by the operator of the first access device.

37. The system of claim 36 wherein the form server is operative with the second access device to send information included in the multi-part form to the operator of the second access device after receiving a request to process the multi-part form by the operator of the second access device.

38. The method of claim 20 wherein the electronic form document is an electronic Certificate of Medical Necessity.

39. The method of claim 38 wherein the electronic Certificate of Medical Necessity includes a first section, a second section, a third section and a fourth section.

40. The method of claim 39 further comprising the step of recording the information received from the representative of the supplier and the information received from the representative of the physician to create a completed electronic Certificate of Medical Necessity.

41. The method of claim 40 wherein only the information received from the representative of the physician is used to complete the second section of the electronic Certificate of Medical Necessity and wherein only the information received from the representative of the supplier is used to complete the third section of the electronic Certificate of Medical Necessity and wherein only the information received from the physician is used to complete the fourth section of the electronic Certificate of Medical Necessity.
